(19) United States
(12) Patent Application Publication
(10) Pub. No.: US 2017/0009840 A1
(43) Pub. Date: Jan. 12, 2017

(54) Vibration Damper Having An End Stop

(71) Applicant: ZF FRIEDRICHSHAFEN AG, Friedrichashafen (DE)

(72) Inventor: Wolfgang Hertz, Sankt Augustin (DE)

(21) Appl. No.: 15/120,796

(22) PCT Filed: Jan. 27, 2015
(86) PCT No.: PCT/EP2015/051568

§ 371 Date: Aug. 23, 2016

(30) Foreign Application Priority Data
Feb. 27, 2014 (DE) 10 2014 203 598.8

(51) Int. Cl. F16F 9/49; F16F 9/19

(52) U.S. Cl. CPC F16F 9/49; F16F 9/19

(57) ABSTRACT

Vibration damper with an end stop operated through a damping medium, includes a cylinder in which a piston rod is guided so as to be axially movable, wherein the piston rod controls a choke ring which limits a compression space starting from a defined stroke position of the piston rod at a cylinder-side wall having reduced diameter, wherein the cylinder has at least one working chamber which is filled with the damping medium and which is connected to the compression space via at least one choke orifice, wherein the choke ring has at least one pressure compensation channel via which a surface of the choke ring facing in direction of the wall on the cylinder side is connected to compression space with respect to the cross section of the choke ring, and the outflow from the pressure compensation channel to the working chamber can be closed in a stroke-dependent manner.

### PRIORITY CLAIM

This is a U.S. national stage of application No. PCT/EP2015/051568, filed on Jan. 27, 2015. Priority is claimed on the following application: Country: Germany, Application No.: 10 2014 203 598.8, Filed: Feb. 27, 2014 ,the content of which is incorporated in its entirety herein by reference.

### FIELD OF THE INVENTION

The invention is directed to a vibration damper with an end stop.

### BACKGROUND OF THE INVENTION

In a vibration damper with a hydraulic end stop known from US2014/360353A1, an end stop ring on which a choke ring is axially supported is fastened to a piston rod. The choke ring is radially preloaded and seals starting from a defined stroke position at a cylinder wall having a reduced diameter. The cylinder wall can be formed by a sleeve which is separate from the cylinder or directly by the cylinder.

However, when the choke ring seals at the outer circumference, a choke cross section is opened through which damping medium is displaced from an end stop space into a working chamber of the cylinder.

The choke ring is not operative within the normal stroke range of the piston rod, and there is a distinct annular gap between the choke ring and an inner wall of the cylinder. This annular gap is defined through an engagement formation which limits the radial expansion of the choke ring in that two locking tabs engage one inside the other. In principle, the engagement formation is not absolutely necessary for maintaining the annular gap, but it facilitates installation and handling of the choke ring.

It has been shown that the choke ring is particularly highly loaded radially outwardly in direction of the cylinder-side wall particularly just before entering the area of reduced diameter. On the one hand, a high mechanical load occurs for the choke ring, as a result of which the engagement formation is destroyed, for example, and on the other hand an appreciable force surge can be noted at the transition into the area of reduced diameter.

A first solution was to increase the radial thickness of the choke ring. However, a drawback remained in the possibly greater radial preloading of the choke ring, which increases the friction of the end stop. Depending on installation space specifications, there is also a problem with installation space.

It is an object of the present invention to minimize the problem known from the prior art with respect to the radial expansion of the choke ring.

### SUMMARY OF THE INVENTION

According to the invention, this object is met in that the choke ring has at least one pressure compensation channel via which a surface of the choke ring facing in direction of the wall on the cylinder side is connected to the compression space with respect to the cross section of the choke ring, and the outflow from the pressure compensation channel to the working chamber can be closed in a stroke-dependent manner.

With the at least one pressure compensation channel, a pressure pad at the inner diameter of the choke ring can be removed on the one hand, and a pressure-dependent counterforce can be generated at the surface so that the choke ring is only exposed to a slight resulting radial load. The pressure compensation channel itself does not assume a damping force function when the choke ring moves into the compression space. On the other hand, there is a harmonious transition from the normal stroke range to the deployment of the choke ring.

Accordingly, the choke ring can have a quantity of radial pressure compensation channels which connect an inner surface of the choke ring to the surface facing in direction of the cylinder-side wall. The pressure compensation channels extend over the entire radial width of the choke ring.

To make use of the operative stroke length of the end stop relative to the constructional height of the choke ring, it is optimal when the at least one radial pressure compensation channel is still open when the choke ring moves into the region of the cylinder-side wall having a reduced diameter. When the choke ring has reached the area of reduced diameter, the pressure compensation channel is no longer required and can be closed so as to allow only the choke cross section to remain operative.

According to an advantageous embodiment, the at least one pressure compensation channel is constructed so as to have an axial distance from the end face of the choke ring. A choke ring of this kind can be highly mechanically loaded.

Alternatively, it can be provided that the pressure compensation channel is formed in the end face facing in direction of the compression space, and the outer surface is connected to an inner surface. This embodiment can be produced particularly easily.

There is the further possibility that the choke ring has a quantity of axial pockets which terminate in the outer surface of the choke ring and are connected to the compression space.

A particularly advantageous embodiment is characterized in that the at least one axial pocket extends through an end face facing in direction of the compression space. On one hand, the embodiment can be produced easily by injection molding and, on the other hand, there is high mechanical strength.

### BRIEF DESCRIPTION OF THE DRAWINGS

The invention will be described more fully referring to the following description of the drawings in which:

FIG. 1 is a partially cross-sectional view of installation situation of the end stop;

FIGS. 2-4 are plan and side views of the choke ring with pressure compensation channels;

FIG. 5 is a side view of the choke ring with open pressure compensation channels;

FIGS. 6-8 are plan and side views of pressure compensation channels in the form of pockets.

### DETAILED DESCRIPTION OF THE PRESENTLY PREFERRED EMBODIMENTS

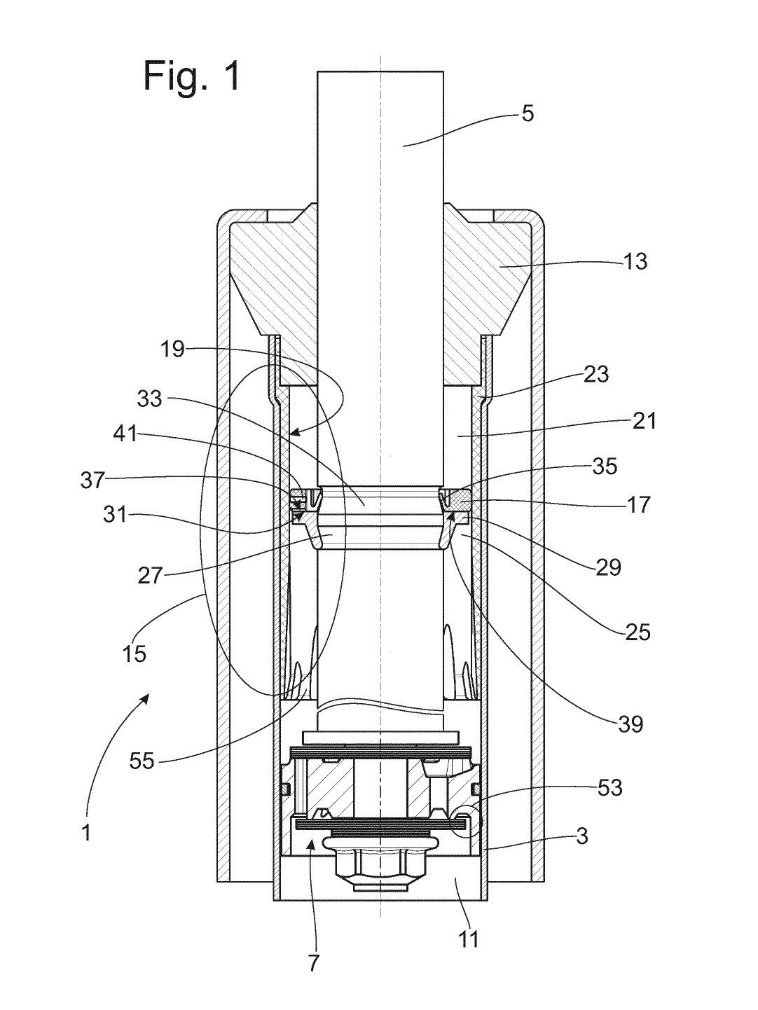

FIG. 1 shows a vibration damper 1 in the constructional form of a twin-tube damper, although the invention is not limited to this constructional form. A piston rod 5 together with a piston 7 is guided in a cylinder 3 so as to be axially movable. The cylinder 3 is divided by the piston 7 into a working chamber 9 proximal to the piston rod and a working chamber 11 distal to the piston rod. Both working chambers 9; 11 are completely filled with a damping medium, generally a liquid damping medium. At the ends, the vibration damper in its entirety is closed by a piston rod guide 13. An end stop 15 which is operated by damping medium inside the cylinder 3 is arranged in the working chamber 9 proximal to the piston rod 5. In principle, an end stop 15 of this kind can also be provided in the working chamber 11 distal to the piston rod 5.

The end stop 15 comprises a choke ring 17 which is supported at the piston rod 5 and which limits a compression space 21 starting from a defined stroke position of the piston rod 5 at a cylinder-side wall 19 having reduced diameter. In this embodiment example, the cylinder-side wall 19 is formed by a sleeve 23 which is fixed between the cylinder 3 and the piston rod guide 13. In principle, the cylinder 3 itself could also have a radial recess which forms the compression space 21. The compression space 21 is likewise completely filled with damping medium.

In order to support the choke ring 17, the piston rod 5 has a supporting ring 25 which is L-shaped in section and is press-fit in a groove 27. A circular web 29 of the supporting ring 25 forms a supporting surface 31. Axially above the supporting ring 25, the piston rod 5 has a second groove 33 which forms an axial positive engagement with radial spring tabs 35 of the choke ring 17. The choke ring 17 is radially elastically supported and can also lift up axially from the supporting surface 31 within limits.

The choke ring 17 has at least one choke orifice 37 which is always open regardless of the position of the choke ring 17 in the compression space 21. The size and/or quantity of choke orifices 37 depends on the end stop force required. In this embodiment example, the choke orifice 37 is formed in an end face 39 facing the supporting ring 25.

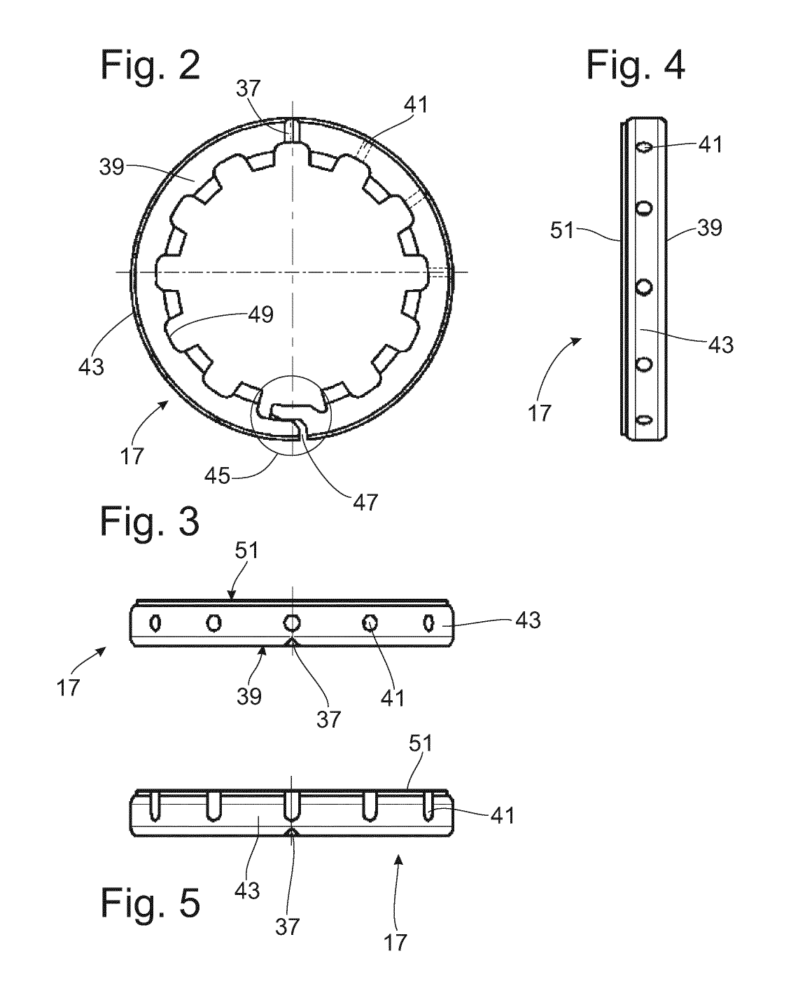

Further, the choke ring 17 has at least one pressure compensation channel 41 which connects a surface 43 of the choke ring 17 facing in direction of the cylinder-side wall 19 to the compression space 21 with respect to the cross section of the choke ring 17 in a stroke-dependent manner. The pressure compensation channel 41 is hydraulically connected in parallel with the choke orifice 37. The choke ring 17 is shown as individual part in different views in FIGS. 2 to 4. FIG. 2 shows the choke ring 17 viewing the end face 39 with the choke orifice 37. Also visible is a lock 45 of a slot 47 in the choke ring 17 so that the choke ring 17 is radially elastic and is radially preloaded in the stroke region of the compression space 21. FIGS. 3 and 4 show the pressure compensation channels 41 which connect an inner surface 49 of the choke ring 17 to the surface 43 facing in direction of the cylinder-side wall 19. FIG. 3 shows that there is an axial distance between the choke cross section 37 and the pressure compensation channels 41. In this embodiment, there is also an axial distance between the pressure compensation channels 41 and an end face 51 facing in direction of the compression space.

During an outward movement of the piston rod 5 in the normal stroke range, there is a radial annular gap between the choke ring 17 and the cylinder wall. The end stop 15 is not operative because the damping medium can flow past the choke ring 17 on the outside in direction of at least one piston valve 53.

During a larger stroke movement of the piston rod 5, the choke ring 17 reaches a lead-in bevel 55 of the sleeve 23 which brings about a gentle transition for the deployment of the end stop 15. Shortly before contact of the choke ring 17 with the lead-in bevel 55, a very small annular gap is present between the choke ring 17 and the lead-in bevel 55. There would be a lower pressure in this small annular gap than in the area of the inner surface 49 if the open pressure compensation channels 41 did not at least partially reduce this pressure difference, since the latter are still open when the choke ring 17 moves into the area of the cylinder-side wall with reduced diameter. Owing to the pressure compensating effect, the choke ring 17 practically hardly expands radially and is now radially supported additionally by the sleeve 23 as the choke ring 17 continues to move inward into the compression space 21. At the end of the lead-in bevel 55, the outlets of the pressure compensation channels 41 from the cylinder-side wall 19 into the working chamber 9 are closed and only the at least one choke orifice 37 is still operative.

During an inward movement of the piston rod 5, the choke ring 17 can lift up somewhat from the supporting ring 25 and releases a greater cross section for filling the compression space 21.

The embodiment according to FIG. 5 is modified over the embodiment according to FIGS. 2 to 4. The difference is that the pressure compensation channels 41 are constructed as open channels which are cast in the end face 51 facing in direction of the compression space 21 and connect the outer surface 43 and the inner surface 49 of the choke ring 17.

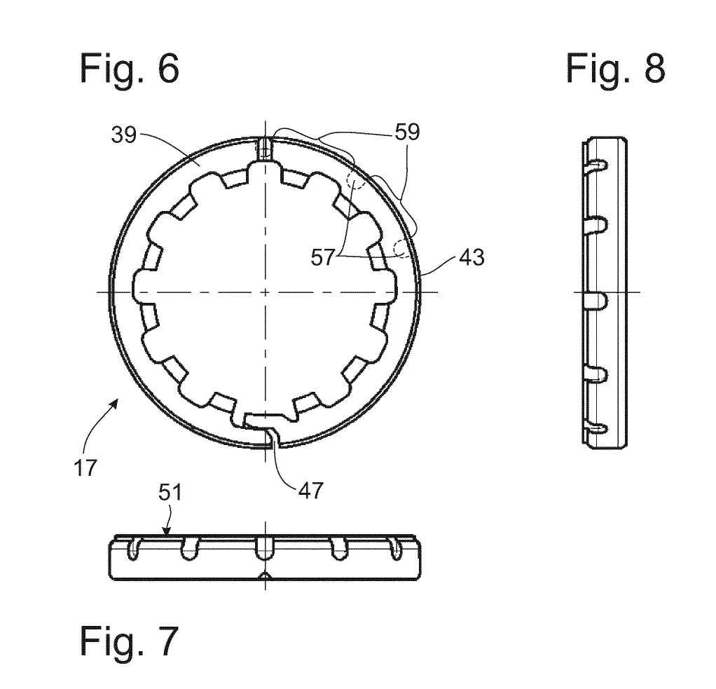

FIGS. 6 to 8 show a version of the choke ring 17 with a quantity of axial pockets 57 which terminate in the outer surface 43 of the choke ring 17 and are connected to the compression space 21. The pockets extend along the entire radial width of the choke ring 17 such that, with the exception of the aforementioned slot 47, there is a continuous end face 39; 51 which mechanically strengthens the choke ring 17. Between the pockets 57 are guide surfaces 59 toward the inner wall of the sleeve 23 which are operative already when the pockets 57 are still connected to the compression space 21. Since they extend through the end face 51 facing in direction of the compression space 21, these pockets 57 are permanently open such that there is also a pressure force component acting radially inward via the incident flow against the pockets 57 when the choke ring 17 exercises its end stop function. Accordingly, there is also a reduced friction force between the choke ring 17 and the sleeve 23 or cylinder-side wall 19 with reduced diameter. While the pockets 57 are permanently open, however, the outflow of the damping medium from the compression space 21 into the working chamber is blocked by the pockets 57.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-7. (canceled)

8. A vibration damper (1) with an end stop (15) operated through a damping medium, comprising:
a cylinder (3) including a side wall (19) having a reduced diameter;
a piston rod (5) guided so as to be axially movable within said cylinder (3);
a choke ring (17) having at least one choke orifice (37) and being controlled by said piston rod (5) for limiting a compression space (21) starting from a defined stroke position of said piston rod (5) at said reduced diameter cylinder-side wall (19);
said cylinder (3) having at least one working chamber (9; 11) filled with the damping medium and connected to the compression space (21) via the at least one choke orifice (37); said choke ring (17) having an outer surface (43) facing said side wall (19) and at least one pressure compensation channel (41, 57) connecting said outer surface (43) to the compression space (21) with respect to a cross-section of said choke ring (17); and wherein an outflow from said pressure compensation channel (41) to said working chamber can be closed in a stroke-dependent manner.

9. The vibration damper according to claim 8, wherein said choke ring (17) comprises a plurality of radial pressure compensation channels (41) connecting an inner surface (49) of said choke ring (17) to said surface (43) facing in the direction of said cylinder-side wall (19).

10. The vibration damper according to claim 8, wherein said at least one radial pressure compensation channel (41) is still open when said choke ring (17) moves into the region of said cylinder-side wall (19) having reduced diameter.

11. The vibration damper according to claim 8, wherein said choke ring (17) comprises an end face (51) and said at least one pressure compensation channel (41) is constructed so as to have an axial distance from said end face (51) of said choke ring.

12. The vibration damper according to claim 8, wherein said choke ring (17) comprises an end face (51) and said pressure compensation channel (41) is formed in said end face (51) facing in the direction of said compression space (21), and said outer surface (43) is connected to an inner surface (49) of said choke ring (17).

13. The vibration damper according to claim 8, wherein said choke ring (17) comprises a plurality of axial pockets (57) terminating in said outer surface (43) of said choke ring (17) and being connected to said compression space (21).

14. The vibration damper according to claim 13, wherein at least one of said plurality of axial pockets (57) extends through said end face (51) facing in direction of said compression space (21).
